(19) United States
(12) Patent Application Publication
(10) Pub. No.: US 2024/0257498 A1
(43) Pub. Date: Aug. 1, 2024

(54) ELECTRONIC APPARATUS FOR CLASSIFYING OBJECT REGION AND BACKGROUND REGION AND OPERATING METHOD OF THE ELECTRONIC APPARATUS

(71) Applicant: SAMSUNG ELECTRONICS CO., LTD., Suwon-si (KR)

(72) Inventor: Soonmook JEONG, Suwon-si (KR)

(73) Assignee: SAMSUNG ELECTRONICS CO., LTD., Suwon-si (KR)

(21) Appl. No.: 18/629,439

(22) Filed: Apr. 8, 2024

Related U.S. Application Data
(63) Continuation of application No. PCT/KR2023/014266, filed on Sep. 20, 2023.

(30) Foreign Application Priority Data
Sep. 27, 2022 (KR) 10-2022-0122873

(51) Int. Cl. G06V 10/764; G06V 10/30; G06V 10/77

(52) U.S. Cl. CPC G06V 10/764; G06V 10/30; G06V 10/7715

(57) ABSTRACT

An electronic apparatus includes: a memory storing at least one instruction; and at least one processor configured to execute the at least one instruction to: obtain an input image by capturing an object and a background of the object through a camera; obtain a first classification map by classifying a first part of the obtained input image as an object region corresponding to the object and a second part of the obtained input image as a background region corresponding to the background of the object; pre-process the first classification map to obtain a second classification map in which a noise region in the first classification map is removed; and obtain an object image corresponding to the object, based on the first classification map and the second classification map, by using the noise region in the first classification map and information about a distance between the camera and the object.

### CROSS-REFERENCE TO RELATED APPLICATIONS

This application is a continuation of International Application No. PCT/KR2023/014266, filed on Sep. 20, 2023, which claims priority to Korean Patent Application No. 10-2022-0122873, filed on Sep. 27, 2022, the disclosures of which are incorporated by reference herein their entireties.

### BACKGROUND

### 1. Field

The disclosure relates to an electronic apparatus for classifying an object region and a background region and an operating method of the electronic apparatus.

### 2. Description of Related Art

With the development of a computer vision technology, a background filter technology has been developed which classifies an object region and a background region in an image, and replaces the background region in the image with a virtual graphic or an opaque screen.

The background filter technology may be used in virtual environments, such as a video call, a camera image-capturing mode, or a metaverse environment.

For example, the background filter technology may be used during a video call to prevent infringement of privacy by replacing a background region, which is a call place, with another background image during a call, or to set a desired place as a background region. However, current background filter technology does not distinguish between an object and a background with sufficient accuracy. Furthermore, distinguishing between the object and background becomes difficult without adequate noise removal.

### SUMMARY

According to an aspect of the disclosure, an electronic apparatus includes: a memory storing at least one instruction; and at least one processor configured to execute the at least one instruction to: obtain an input image by capturing an object and a background of the object through a camera; obtain a first classification map by classifying a first part of the obtained input image as an object region corresponding to the object and a second part of the obtained input image as a background region corresponding to the background of the object; pre-process the first classification map to obtain a second classification map in which a noise region in the first classification map is removed; and obtain an object image corresponding to the object, based on the first classification map and the second classification map, by using the noise region in the first classification map and information about a distance between the camera and the object.

The at least one processor may be further configured to execute the at least one instruction to: obtain a final classification map, based on the first classification map and the second classification map, by using the noise region in the first classification map and the information about the distance between the camera and the object; and obtain the object image by applying the final classification map to the input image.

The second classification map may be a classification map obtained by performing a morphology process on the first classification map.

The at least one processor may be further configured to execute the at least one instruction to determine a first correction coefficient based on the information about the distance between the camera and the object, the first correction coefficient may include a first sub-correction coefficient and a second sub-correction coefficient, as the distance between the camera and the object increases, a magnitude of the first sub-correction coefficient may decrease, and as the distance between the camera and the object increases, a magnitude of the second sub-correction coefficient may increase, and the at least one processor may be further configured to execute the at least one instruction to obtain the object image based on the first classification map multiplied by the first sub-correction coefficient and the second classification map multiplied by the second sub-correction coefficient.

The at least one processor may be further configured to execute the at least one instruction to determine a second correction coefficient based on the noise region, as a ratio of the noise region to the object region in the first classification map increases, a magnitude of the second correction coefficient may increase, and the at least one processor may be further configured to execute the at least one instruction to obtain the object image based on the second classification map multiplied by the second correction coefficient.

The second correction coefficient may be determined based on at least one of the ratio of the noise region to the object region, a number of noise regions, or an area of the noise region.

The input image may include a plurality of pixel images, and the at least one processor may be further configured to execute the at least one instruction to: determine, for each pixel image in the plurality of pixel images, a probability value of a probability that a respective pixel image corresponds to the object based on the input image; and obtain the first classification map by classifying each pixel image in the plurality of pixel images as one of the object region and the background region based on an arrangement of the plurality of pixel images and a result of comparing a preset first reference probability value with the determined probability value for each pixel image.

The at least one processor may be further configured to execute the at least one instruction to, after obtaining the first classification map, classify the noise region in the object region, based on a result of comparing a preset second reference probability value with a probability value of a probability that at least one pixel image from the plurality of pixel images in the classified object region corresponds to the object, and the second reference probability value may be different from the first reference probability value.

The at least one processor may be further configured to execute the at least one instruction to obtain the object image, based on the first classification map and the second classification map, by using the first correction coefficient, the second correction coefficient, and a third correction coefficient determined based on a probability value of a probability that at least one pixel image in the noise region corresponds to the object.

The third correction coefficient may be inversely proportional to the probability value of the probability that the at least one pixel image in the noise region corresponds to the object, and the at least one processor may be further configured to execute the at least one instruction to obtain the object image based on the second classification map multiplied by the third correction coefficient.

According to an aspect of the disclosure, an operating method of an electronic apparatus, includes: obtaining an input image by capturing an object and a background of the object through a camera; obtaining a first classification map by classifying a first part of the obtained input image as an object region corresponding to the object and a second part of the obtained input image as a background region corresponding to the background of the object; pre-processing the first classification map to obtain a second classification map in which a noise region in the first classification map is removed; and obtaining an object image corresponding to the object, based on the first classification map and the second classification map, by using the noise region in the first classification map and information about a distance between the camera and the object.

The operating method may further include obtaining a final classification map, based on the first classification map and the second classification map, by using the noise region in the first classification map and the information about the distance between the camera and the object, and the obtaining of the object image may include obtaining the object image by applying the final classification map to the input image.

A first correction coefficient determined based on the information about the distance between the camera and the object may include a first sub-correction coefficient and a second sub-correction coefficient, as the distance between the camera and the object increases, a magnitude of the first sub-correction coefficient may decrease, and as the distance between the camera and the object increases, a magnitude of the second sub-correction coefficient may increase, and the obtaining of the object image may include obtaining the object image based on the first classification map multiplied by the first sub-correction coefficient and the second classification map multiplied by the second sub-correction coefficient.

As a ratio of the noise region to the object region in the first classification map increases, a magnitude of a second correction coefficient determined based on the noise region may increase, and the obtaining the object image may include obtaining the object image based on the second classification map multiplied by the second correction coefficient.

The second correction coefficient may be determined based on at least one of the ratio of the noise region to the object region, a number of noise regions, or an area of the noise region.

The input image may include a plurality of pixel images, the operating method of the electronic apparatus may further include determining, for each pixel image in the plurality of pixel images, a probability value of a probability that a respective pixel image corresponds to the object based on the input image, and the obtaining the first classification map may include obtaining the first classification map by classifying each pixel image in the plurality of pixel images as one of the object region and the background region based on an arrangement of the plurality of pixel images and a result of comparing a preset first reference probability value with the determined probability value.

The operating method may further include, after the obtaining the first classification map, classifying the noise region in the object region, based on a result of comparing a preset second reference probability value with a probability value of a probability that at least one pixel image from the plurality of pixel images in the classified object region corresponds to the object, and the first reference probability value may be different from the second reference probability value.

The obtaining the object image may include obtaining the object image based on the first classification map and the second classification map, by using the first correction coefficient, the second correction coefficient, and a third correction coefficient determined based on a probability value of a probability that at least one pixel image in the noise region corresponds to the object.

The third correction coefficient may be inversely proportional to the probability value of the probability that the at least one pixel image included in the noise region corresponds to the object, and the obtaining the object image may include obtaining the object image based on the second classification map multiplied by the third correction coefficient.

According to an aspect of the disclosure, an non-transitory computer-readable recording medium having instructions stored therein, which when executed by a processor in an electronic apparatus cause the processor to perform the operating method.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram for describing an electronic apparatus according to one or more embodiments of the disclosure;

FIG. 2 is a block diagram for describing an electronic apparatus according to one or more embodiments of the disclosure;

FIG. 3 is a flowchart for describing an operation of an electronic apparatus, according to one or more embodiments of the disclosure;

FIG. 4 is a diagram for describing an operation of an electronic apparatus, according to one or more embodiments of the disclosure;

FIG. 5A is a diagram for describing an operation of obtaining a first classification map, according to one or more embodiments of the disclosure;

FIG. 5B is a diagram for describing the first classification map according to one or more embodiments of the disclosure;

FIG. 6A is a diagram for describing an operation of obtaining a second classification map, according to one or more embodiments of the disclosure;

FIG. 6B is a diagram for describing the second classification map according to one or more embodiments of the disclosure;

FIG. 7A is a diagram for describing an operation of obtaining a first correction coefficient, according to one or more embodiments of the disclosure;

FIG. 7B is a diagram for describing the first correction coefficient according to one or more embodiments of the disclosure;

FIG. 8A is a diagram for describing an operation of obtaining a second correction coefficient and a third correction coefficient, according to one or more embodiments of the disclosure;

FIG. 8B is a diagram for describing the second correction coefficient and the third correction coefficient according to one or more embodiments of the disclosure;

FIG. 9 is a diagram for describing an operation of obtaining a final classification map, according to one or more embodiments of the disclosure; and

FIG. 10 is a diagram for describing effects of an electronic apparatus and an operating method of the electronic apparatus, according to one or more embodiments of the disclosure.

### DETAILED DESCRIPTION

Throughout the disclosure, the expression “at least one of a, b or c” indicates only a, only b, only c, both a and b, both a and c, both b and c, or all of a, b, and c.

The terms as used herein are briefly described, and one or more embodiments of the disclosure is described in detail.

As for the terms as used herein, common terms that are currently widely used are selected as much as possible while taking into account functions in one or more embodiments of the disclosure. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of the embodiment of the disclosure. Therefore, the terms as used herein should be defined based on the meaning of the terms and the description throughout the disclosure rather than simply the names of the terms.

The singular forms as used herein are intended to include the plural forms as well unless the context clearly indicates otherwise. All terms including technical or scientific terms as used herein have the same meaning as commonly understood by those of ordinary skill in the art.

Throughout the disclosure, the expression “a portion includes a certain element” means that a portion further includes other elements rather than excludes other elements unless otherwise stated. Also, the terms such as “ . . . er/or” and “module” as used herein refer to units that process at least one function or operation, and may be implemented as hardware, software, or a combination of hardware and software.

The expression “configured to” as used herein may be used interchangeably with, for example, “suitable for,” “having the capacity to,” “designed to,” “adapted to,” “made to,” or “capable of” depending on a situation. The term “configured to” may not necessarily mean only “specifically designed to” in hardware. Instead, in some situations, the expression “a system configured to” may mean that the system is “capable of . . . ” with other devices or components. For example, “a processor configured to perform A, B, and C” may refer to a dedicated processor (e.g., an embedded processor) for performing corresponding operations or a generic-purpose processor (e.g., a central processing unit (CPU) or an application processor) capable of performing corresponding operations by executing one or more software programs stored in a memory.

Also, when one element is referred to as “connected” or “coupled” to another element, the one element may be directly connected or coupled to the other element, but it will be understood that the elements may be connected or coupled to each other via an intervening element therebetween unless the context clearly indicates otherwise.

Hereinafter, one or more embodiments of the disclosure will be described in detail with reference to the accompanying drawings, so that those of ordinary skill in the art may easily carry out the disclosure. However, the disclosure may be implemented in various different forms and is not limited to the embodiment described herein. In order to clearly explain one or more embodiments of the disclosure, parts irrelevant to the description are omitted in the drawings, and similar reference numerals are assigned to similar parts throughout the disclosure.

Hereinafter, embodiments of the disclosure will be described in described in detail with reference to the drawings.

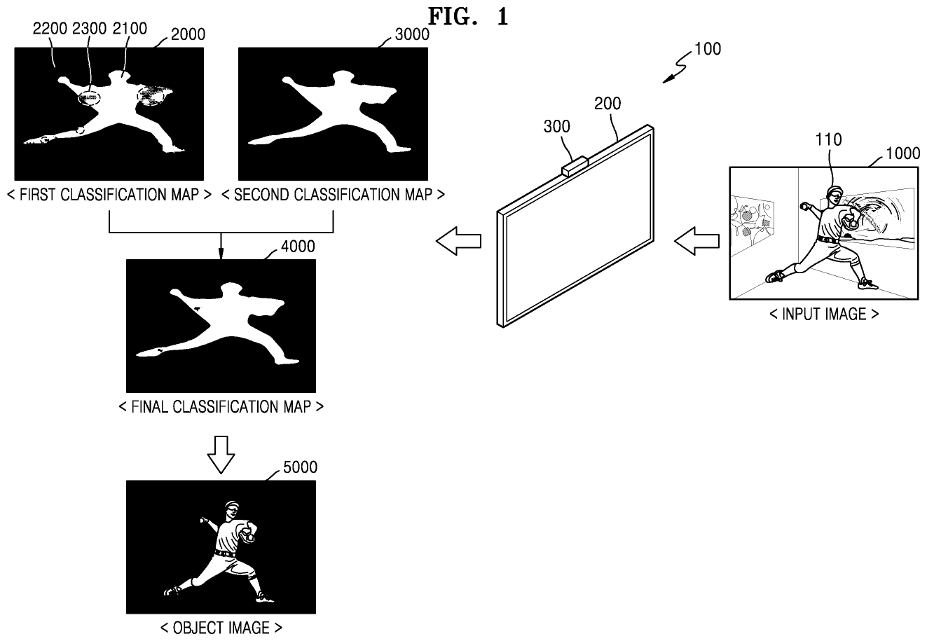

FIG. 1 is a diagram for describing an electronic apparatus 100 according to one or more embodiments of the disclosure.

Referring to FIG. 1, the electronic apparatus 100 according to one or more embodiments of the disclosure may include a display panel 200 and a camera 300. In one or more embodiments of the disclosure, the camera 300 may photograph or capture an image of a user 110 located in front of the electronic apparatus 100 and a background of the user 110. Hereinafter, for convenience of description, the user 110 that is photographed by the camera 300 is defined as an object, and the background of the user 110 may be defined as a background of the object. The electronic apparatus 100 may obtain an input image 1000 including the object 110 photographed by the camera 300 and the background of the object 110. In one or more embodiments of the disclosure, although a person throwing a ball is illustrated as the object 110 in FIG. 1, the embodiments are not limited thereto. The object 110 may be a user that uses the electronic apparatus 100. When there is at least one user that uses the electronic apparatus 100, the camera 300 may obtain the input image 1000 by photographing the at least one user and the background of the at least one user. In one or more examples, the camera 300 may photograph or capture an image of an object located in front of the electronic apparatus 100 and a background of the object. In this case, the object may be an object disposed in front of the electronic apparatus 100. The camera may take a still image of an object, or may capture a sequence of images forming a video.

However, the embodiments are not limited thereto, and the camera 300 may not be included in the electronic apparatus 100. The electronic apparatus 100 may receive the input image 1000 including an object and a background of the object, which are photographed by a camera included in a separate electronic apparatus. In this case, the electronic apparatus 100 may obtain an object image 5000 based on a processing of the received input image 1000. In one or more embodiments of the disclosure, the user 110 that uses the electronic apparatus 100 may be different from the object included in the input image 1000 obtained by the camera 300.

Hereinafter, for convenience of description, it is assumed that the input image 1000 is an image captured by the camera 300 included in the electronic apparatus 100. However, as understood by one of ordinary skill in the art, the camera 300 may be separate from the electronic apparatus 100.

In one or more embodiments of the disclosure, the electronic apparatus 100 may obtain a first classification map 2000 in which the input image 1000 is classified into an object region 2100 corresponding to an object and a background region 2200 corresponding to a background of the object based on the obtained input image 1000.

In one or more embodiments of the disclosure, the electronic apparatus 100 may pre-process the first classification map 2000 to obtain a second classification map 3000 from which a noise region 2300 included in the first classification map 2000 is removed. The second classification map 3000 may be obtained by removing the noise region 2300 included in the object region 2100 through comparison with the first classification map 2000 and smoothing a boundary between the object region 2100 and the background region 2200.

In one or more embodiments of the disclosure, the electronic apparatus 100 may obtain an object image 5000 corresponding to the object 110, based on the first classification map 2000 and the second classification map 3000, by using information about the distance between the camera 300 and the object 110 and the noise region 2300 included in the first classification map 2000. The electronic apparatus 100 may obtain a final classification map 4000 based on the first classification map 2000 and the second classification map 3000 by using the information about the distance between the camera 300 and the object 110 and the noise region 2300 included in the first classification map 2000, and may obtain the object image 5000 by applying the obtained final classification map 4000 to the input image 1000. The final classification map 4000 may have high accuracy in classifying the object region corresponding to the object 110 and the background region corresponding to the background of the object, compared to the first classification map 2000 and the second classification map 3000. The information about the distance between the camera 300 and the object may be estimated by the camera 300 or by the electronic apparatus. The distance may be estimated based on a size of the object in an image as well as a zoom power of a lens of the camera at the time of capturing the image of the object.

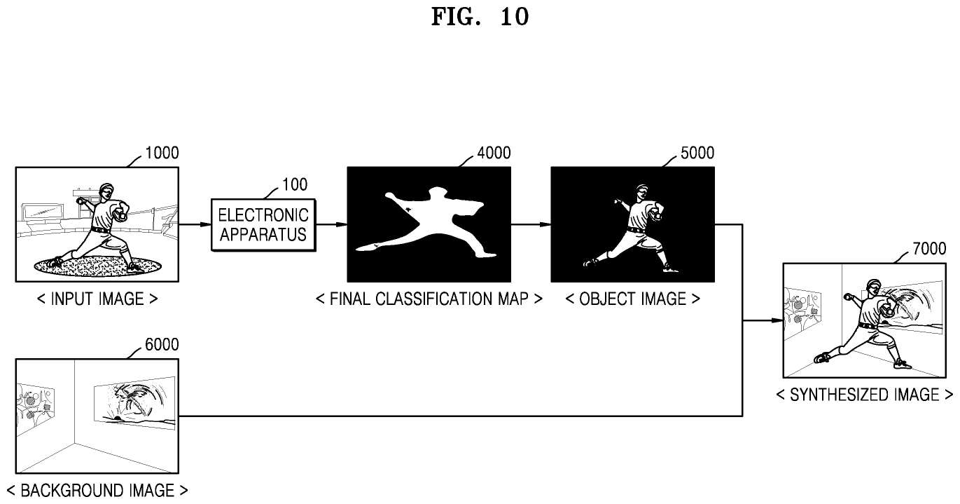

In one or more embodiments of the disclosure, the electronic apparatus 100 may obtain the final classification map 4000 based on the input image 1000 including the object previously obtained by the camera 300 and the background of the object. The electronic apparatus 100 may display, on the display panel 200, the object image 5000 obtained by applying the obtained final classification map 4000 to the input image 1000 so that the object image 5000 is provided to the user of the electronic apparatus 100. Furthermore, in one or more embodiments of the disclosure, the electronic apparatus 100 may provide, to the user of the electronic apparatus 100, a synthesized image 7000 obtained by combining the obtained object image 5000 with another background image (e.g., 6000 of FIG. 10), instead of the background image of the object.

In one or more embodiments of the disclosure, the electronic apparatus 100 may provide at least one of the obtained final classification map 4000, the object image 5000, or the synthesized image 7000 to a separate electronic apparatus.

Hereinafter, a case where the electronic apparatus 100 obtains the first classification map 2000, the second classification map 3000, and the final classification map 4000 in order to obtain the object image 5000 from the input image 1000 will be described with reference to the following drawings.

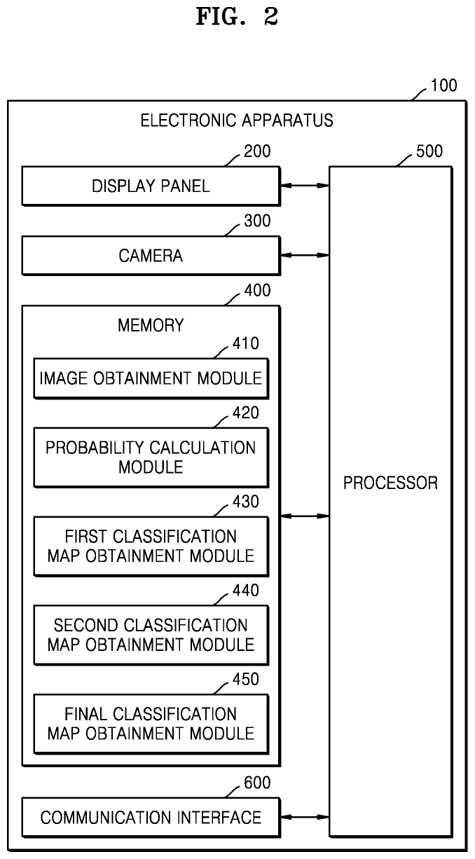

FIG. 2 is a block diagram for describing the electronic apparatus 100 according to one or more embodiments of the disclosure.

As illustrated in FIG. 2, the electronic apparatus 100 according to one or more embodiments of the disclosure may include a display panel 200, a camera 300, a memory 400, a processor 500, and a communication interface 600. However, all of the elements illustrated in FIG. 2 are merely examples that may be implemented with one or more other components known to one of ordinary skill in the art. The electronic apparatus 100 may be implemented with more elements than the elements illustrated in FIG. 2, or may be implemented with fewer elements than the elements illustrated in FIG. 2. The display panel 200, the camera 300, the memory 400, the processor 500, and the communication interface 600 may be electrically and/or physically connected to each other. Hereinafter, the same elements as those described with reference to FIG. 1 are denoted by the same reference numerals, and descriptions thereof are omitted.

In one or more embodiments of the disclosure, the display panel 200 may include one of a liquid crystal display, a plasma display, an organic light-emitting diode display, and an inorganic light-emitting diode display. However, the embodiments are not limited thereto, and the display panel 200 may include other types of displays known to one of ordinary skill in the art capable of providing the object image (e.g., 5000 of FIG. 1) to the user.

In one or more embodiments of the disclosure, the camera 300 may include an RGB camera, an infrared ray (IR) camera, and an RGB-depth camera. However, the embodiments are not limited thereto, and the camera 300 may include other types of cameras, sensors, or any other object capturing device known to one of ordinary skill in the art capable of photographing the user 110 and the background of the user 110. In one or more embodiments of the disclosure, the camera 300 may be detachable from the electronic apparatus, where the camera 300 is detached from the electronic apparatus 100 when not in operation, and attached to the electronic apparatus 100 when in operation. In one or more embodiments of the disclosure, the camera 300 may be electrically and/or physically connected to the electronic apparatus 100 when photographing the object 110 and the background of the object 110 in order to obtain the input image 1000. Also, in one or more embodiments of the disclosure, the electronic apparatus 100 may not include the camera 300. The electronic apparatus 100 may not include the camera 300 and may obtain the input image 1000 captured by a camera included in a separate electronic apparatus. In one or more examples, the electronic apparatus 100 may receive the input image 1000 captured by a camera that is remotely located from the electronic apparatus 100.

In one or more embodiments of the disclosure, the memory 400 may include at least one of flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), mask ROM, flash ROM, hard disk drive (HDD), or solid state drive (SSD). The memory 400 may store instructions or program code for performing the functions or operations of the electronic apparatus 100. The instructions, algorithms, data structures, program code, and application programs, which are stored in the memory 400, may be implemented in, for example, programming or scripting languages, such as C, C++, Java, or assembler.

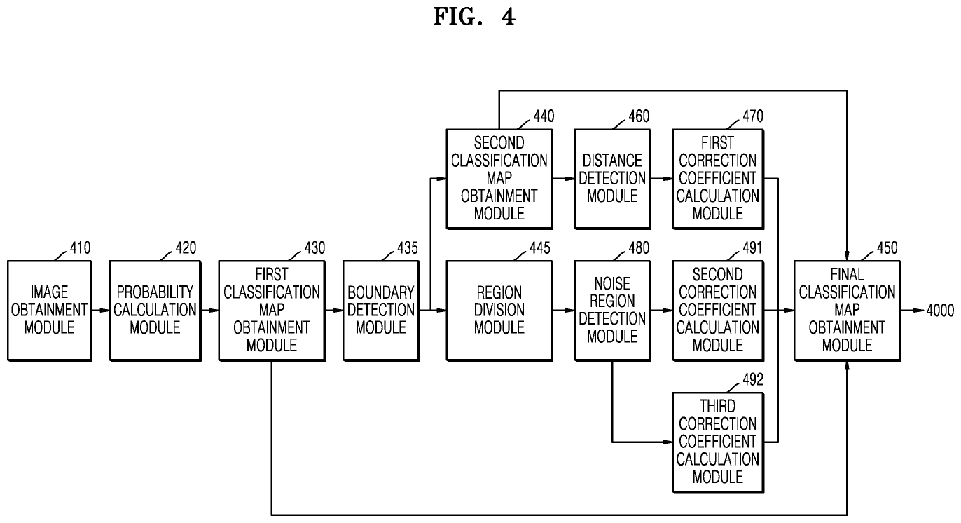

In one or more embodiments of the disclosure, the memory 400 may store various types of modules that is usable to obtain the final classification map (e.g., 4000 of FIG. 1), based on the input image (e.g., 1000 of FIG. 1) obtained by the electronic apparatus 100. The memory 400 may store an image obtainment module 410, a probability calculation module 420, a first classification map obtainment module 430, a second classification map obtainment module 440, and a final classification map obtainment module 450. However, all of the modules illustrated in FIG. 2 are merely examples that may be replaced with one or more additional modules. The memory 400 may store more modules than the modules illustrated in FIG. 2, or may store fewer modules than the modules illustrated in FIG. 2. In one or more embodiments of the disclosure, the memory 400 may store a module that performs the operation of obtaining the object image (e.g., 5000 of FIG. 1) by applying the final classification map 4000 to the input image 1000. In one or more embodiments of the disclosure, the memory 400 may store a boundary detection module 435, a region division module 445, a first correction coefficient calculation module 470, a second correction coefficient calculation module 491, and a third correction coefficient calculation module 492, which will be described with reference to FIG. 4.

In one or more examples, the “modules” included in the memory 400 may refer to units that process the functions or operations to be performed by the at least one processor 500. The “modules” included in the memory 400 may be implemented as software, such as instructions, algorithms, data structures, or program code.

In one or more embodiments of the disclosure, the image obtainment module 410 may include instructions or program code related to the operation or function of obtaining the input image 1000 by photographing or capturing an image of the object and the background of the object through the camera 300. However, the embodiments are not limited thereto, and the image obtainment module 410 may include instructions or program code related to the operation or function of obtaining, from a separate electronic apparatus, an input image by photographing an object and a background of the object.

In one or more embodiments of the disclosure, the obtained input image 1000 may include a plurality of pixel images. Each of the pixel images may correspond to one or more pixels constituting the input image 1000. The pixel may be a unit image constituting the input image 1000. In one or more embodiments of the disclosure, the probability calculation module 420 may include instructions or program code related to an operation or function of calculating a probability that each of the pixel images corresponds to the object or the background of the object, based on the obtained input image 1000. In one or more embodiments of the disclosure, the probability calculation module 420 may include instructions or program code related to an operation or function of calculating a probability that each of the pixel images included in the input image 1000 is a pixel image corresponding to the object and a probability that each of the pixel images included in the input image 1000 is a pixel image corresponding to the background of the object.

In one or more embodiments of the disclosure, the probability calculation module 420 may include an artificial intelligence (AI) model. In one or more embodiments of the disclosure, the artificial AI model included in the probability calculation module 340 may be an artificial AI model trained to calculate a probability that each of the pixel images included in the input image 1000 is a pixel image corresponding to the object or the background of the object, based on the input image 1000.

In one or more embodiments of the disclosure, the artificial AI model included in the probability calculation module 420 may include a machine learning model or a deep learning model. In one or more embodiments of the disclosure, the AI model included in the probability calculation module 420 may include a plurality of neural network layers. Each of the neural network layers may have multiple weight values and may perform an operation of a present neural network layer through an operation result of a previous neural network layer and a calculation of multiple weight values. Examples of the AI model may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, a generative adversarial network (GAN), and a variational auto encoder (VAE). The AI model included in the probability calculation module 420 according to the embodiments are not limited to the examples described above.

In one or more embodiments of the disclosure, the AI model included in the probability calculation module 420 may be an AI model trained to calculate a probability that each of the pixel images included in the input image 1000 is a pixel image corresponding to the object or the background of the object, based on a training dataset labeled with the object and the background of the object. In one or more embodiments of the disclosure, the weight values of the probability calculation module 420 may be updated based on the training dataset.

In one or more embodiments of the disclosure, the electronic apparatus 100 may train the AI model included in the probability calculation module 420. The electronic apparatus 100 may use a pre-trained model in order to train the AI model included in the probability calculation module 420. However, the embodiments are not limited thereto, and the probability calculation module 420 may receive the pre-trained AI model from an external server or peripheral electronic apparatuses through the communication interface 600.

Hereinafter, for convenience of description, it is assumed that the probability calculation module 420 includes instructions or program code related to the operation or function of calculating a probability that each of the pixel images included in the input image 1000 is a pixel image corresponding to the object. In one or more examples, the calculated probability that each of the pixel images is the pixel image corresponding to the object is referred to as an object pixel probability value.

In one or more embodiments of the disclosure, the probability calculation module 420 may include instructions or program code related to an operation or function of classifying the pixel images into the object image 5000 corresponding to the object and the object background image corresponding to the background of the object based on the arrangement of the pixel images and the object pixel probability values of the pixel images.

In one or more embodiments of the disclosure, the first classification map obtainment module 430 may include instructions or program code related to an operation or function of classifying as the object region 2100 corresponding to the object, a region in which at least one pixel image having an object pixel probability value equal to or greater than a preset first reference probability value is disposed. The first classification map obtainment module 430 may include instructions or program code related to an operation or function of classifying as the background region 2200 corresponding to the object background image, a region in which at least one pixel image having an object pixel probability value less than the preset first reference probability value. In one or more embodiments of the disclosure, the first reference probability value may be a reference value for classifying the input image 1000 into one of the object image 5000 and the object background image.

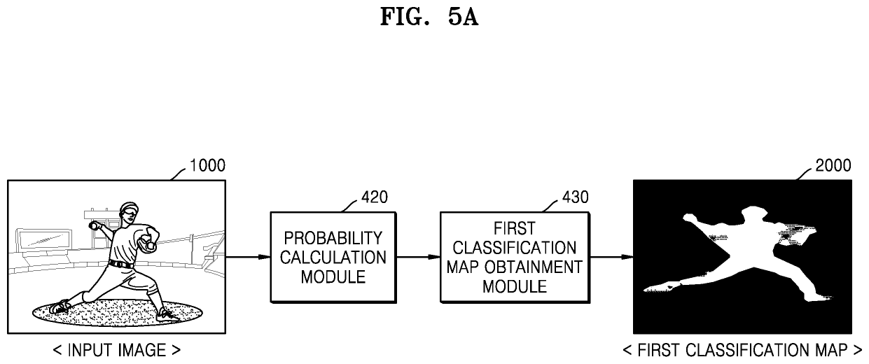

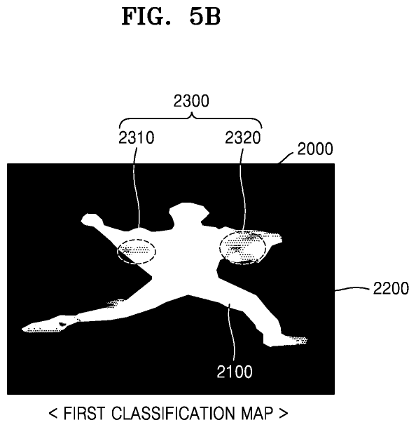

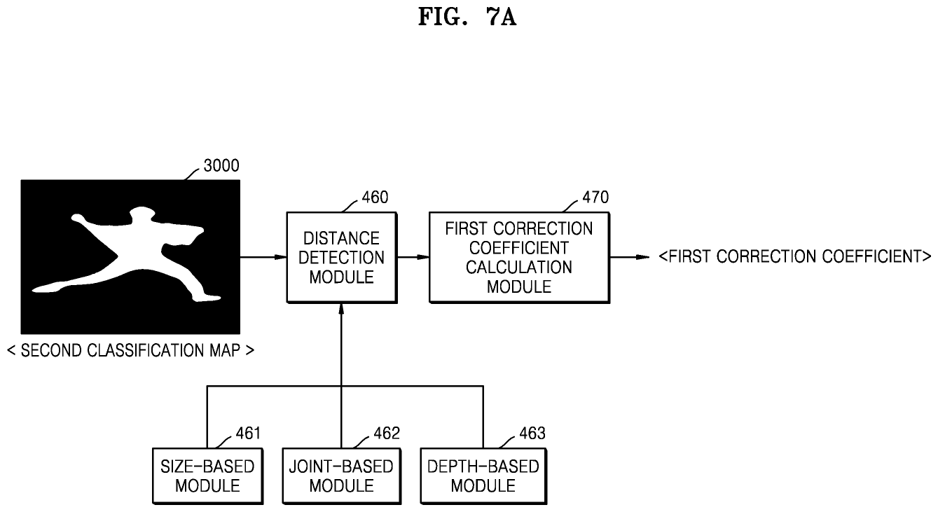

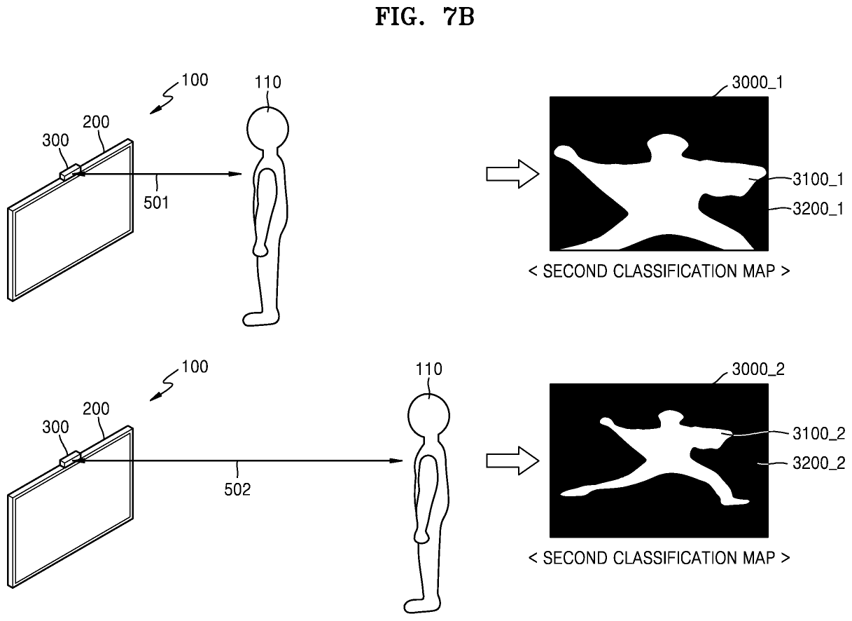

In one or more embodiments of the disclosure, the noise region (e.g., 2300 of FIG. 1) including at least one pixel image having an object pixel probability value less than a preset second reference probability value may be included in the region classified into the object region 2100 by the first classification map obtainment module 430. In one or more embodiments of the disclosure, the second reference probability value may be different from the first reference probability value. The second reference probability value may be greater than the first reference probability value. The noise region 2300 will be described with reference to FIGS. 5B and 7B.

In one or more embodiments of the disclosure, the first classification map obtainment module 430 may include instructions or program code related to an operation or function of obtaining the first classification map 2000 by converting the object pixel probability value calculated by the first classification map obtainment module 430 into a gray scale.

In one or more embodiments of the disclosure, the first classification map 2000 may be an image having a gray scale between 0 and 255, which is obtained by multiplying the object pixel probability value of each of the pixel images included in the input image 1000 by 255. In this case, a pixel image having a larger object pixel probability value may have a higher gray scale, and a pixel image having a smaller object pixel probability value may have a lower gray scale. Accordingly, the object region 2100 included in the first classification map 2000 may be a region having a high gray scale, and the background region 2200 may be a region having a low gray scale. However, the embodiments are not limited thereto. The first classification map 2000 may be an image having a gray scale between 0 and a reference gray scale according to the reference gray scale multiplied by the object pixel probability value of each of the pixel images included in the input image 1000.

In one or more embodiments of the disclosure, the second classification map obtainment module 440 may include instructions or program code related to an operation or function of pre-processing the first classification map 2000 to obtain the second classification map 3000 from which the noise region 2300 included in the first classification map 2000 is removed. In one or more embodiments of the disclosure, the second classification map obtainment module 440 may include instructions or program code related to an operation or function of obtaining the second classification map 3000 from which the noise region 2300 included in the first classification map 2000 is removed through morphology. In one or more embodiments of the disclosure, the second classification map obtainment module 440 may include instructions or program code related to an operation or function of performing erosion, dilatation, and opening/closing/gradient operations through erosion and dilation in order to remove the noise region 2300 included in the first classification map 2000. Hereinafter, the noise region 2300 will be described with reference to 5A to 7B.

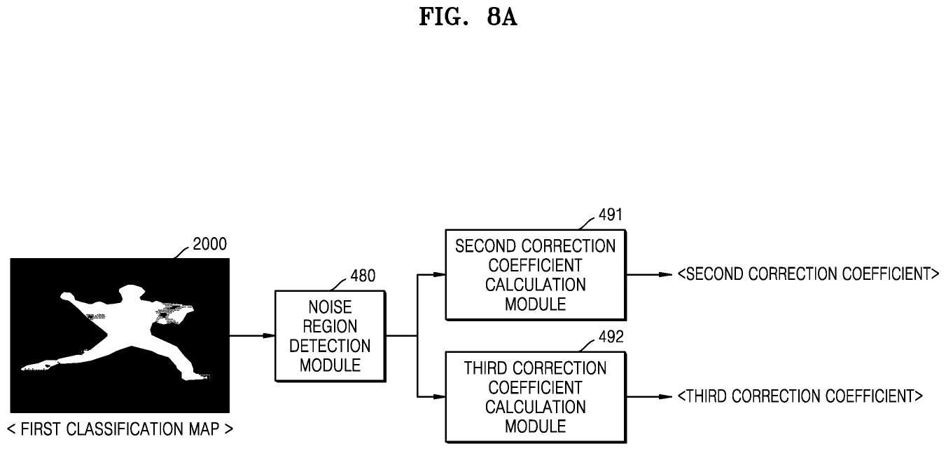

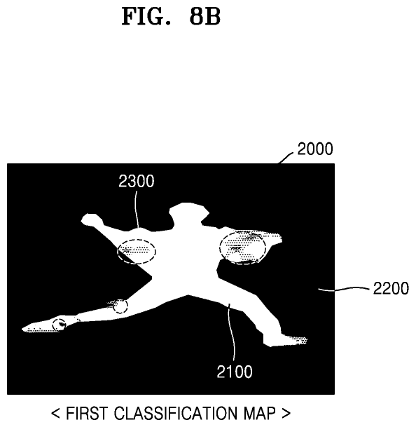

In one or more embodiments of the disclosure, the final classification map obtainment module 450 may include instructions or program code related to an operation or function of obtaining the final classification map 4000 based on the first classification map 2000 and the second classification map 3000. In one or more embodiments of the disclosure, the final classification map obtainment module 450 may include instructions or program code related to an operation or function of obtaining the first correction coefficient calculated based on information about the distance between the camera and the object, the second correction coefficient calculated based on the noise region 2300, and the final classification map 4000 based on the first classification map 2000 and the second classification map 3000. In one or more embodiments of the disclosure, the final classification map obtainment module 450 may include instructions or program code related to an operation or function of obtaining the final classification map 4000 based on the first correction coefficient, the second correction coefficient, the third correction coefficient calculated based on the probability value of the probability that at least one pixel image included in the noise region 2300 corresponds to the object, the first classification map 2000, and the second classification map 3000. Hereinafter, the first to third correction coefficients will be described in the description of FIGS. 7A to 8B.

The processor 500 may include at least one of a central processing unit, a microprocessor, a graphic processing unit, an application processor (AP), application specific integrated circuits (ASICs), digital signal processors (DSPs), digital signal processing devices (DSPDs), programmable logic devices (PLDs), field programmable gate arrays (FPGAs), a neural processing unit, or AI-only processors designed with a hardware structure specialized for learning and processing of an AI model, but the embodiments are not limited thereto.

In one or more embodiments of the disclosure, the processor 500 may execute various types of modules stored in the memory 400. In one or more embodiments of the disclosure, the processor 500 may execute the image obtainment module 410, the probability calculation module 420, the first classification map obtainment module 430, the second classification map obtainment module 440, and the final classification map obtainment module 450, which are stored in the memory 400. In one or more embodiments of the disclosure, the processor 500 may execute at least one instruction constituting various types of modules stored in the memory 400.

In one or more embodiments of the disclosure, the communication interface 600 may perform data communication with an external server under the control of the processor 500. In one or more examples, the communication interface 600 may perform data communication with other peripheral electronic apparatuses as well as the external server. The communication interface 600 may perform data communication with the external server or other peripheral electronic apparatuses by using at least one of data communication schemes including, for example, wired local area network (LAN), wireless LAN, Wireless Fidelity (Wi-Fi), Bluetooth, ZigBee, Wi-Fi Direct (WFD), Infrared Data Association (IrDA), Bluetooth Low Energy (BLE), Near Field Communication (NFC), Wireless Broadband Internet (Wibro), World Interoperability for Microwave Access (WiMAX), Shared Wireless Access Protocol (SWAP), Wireless Gigabit Alliance (WiGig), and radio frequency (RF) communication.

In one or more embodiments of the disclosure, the communication interface 600 may receive the pre-trained probability calculation module 420 from the external server or the peripheral electronic apparatuses in order to calculate the probability that each of the pixel images included in the input image 1000 is the pixel image corresponding to the object.

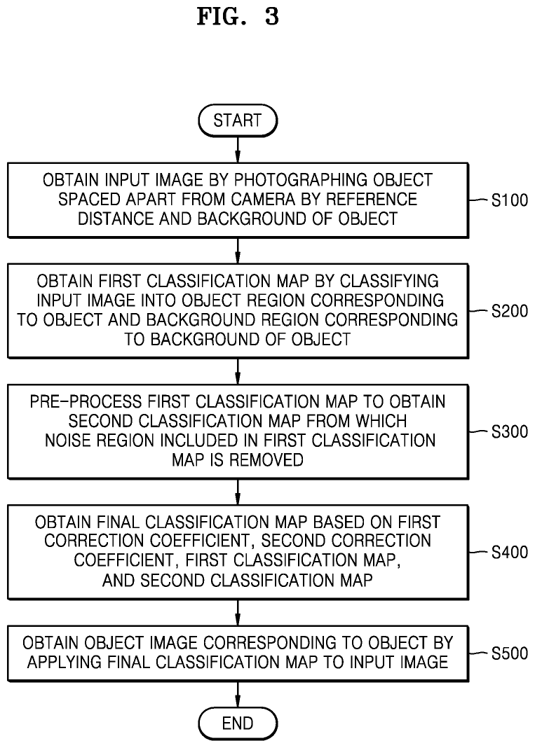

FIG. 3 is a flowchart for describing the operation of the electronic apparatus 100, according to one or more embodiments of the disclosure. FIG. 4 is a diagram for describing the operation of the electronic apparatus 100, according to one or more embodiments of the disclosure.

Referring to FIGS. 1, 3, and 4, in one or more embodiments of the disclosure, the operating method of the electronic apparatus 100 may include obtaining the input image (e.g., 1000 of FIG. 1) by photographing or capturing an image of the object spaced apart from the camera 300 by a reference distance and the background of the object (S100). In one or more embodiments of the disclosure, the reference distance refers to the distance between the camera 300 and the object. The at least one processor (e.g., 500 of FIG. 2) may execute the image obtainment module 410 to obtain the input image 1000 through the camera 300.

In one or more embodiments of the disclosure, the operating method of the electronic apparatus 100 may include calculating an object pixel probability value of each of the pixel images included in the obtained input image 1000. The at least one processor 500 may execute the probability calculation module 420 to calculate the object pixel probability value of each of the pixel images included in the obtained input image 1000.

In one or more embodiments of the disclosure, the operating method of the electronic apparatus 100 may include obtaining the first classification map 2000 by classifying a first part of the input image 1000 as the object region 2100 corresponding to the object and a second part of the input image 1000 as the background region 2200 corresponding to the background of the object (S200).

In one or more embodiments of the disclosure, the obtaining of the first classification map 2000 (S200) may include classifying the pixel images as one of the object region 2100 and the background region 2200 based on the arrangement of the pixel images and a result of comparing the object pixel probability value of each of the pixel images with a preset first reference probability value. The at least one processor 500 may execute the first classification map obtainment module 430 to classify, as the object region 2100, the region in which at least one pixel image having an object pixel probability value equal to or greater than the preset first reference probability value is disposed. The at least one processor 500 may execute the probability calculation module 420 to classify that the region in which at least one pixel image having an object pixel probability value less than the preset first reference probability value is disposed corresponds to the background region 2200.

In one or more embodiments of the disclosure, the obtaining of the first classification map 2000 (S200) may include obtaining the first classification map 2000 by converting the object pixel probability value of each of the pixel images into a gray scale value. The at least one processor 500 may execute the first classification map obtainment module 430 to obtain the first classification map 2000 having a gray scale value between 0 and 255 by multiplying the object pixel probability value of each of the pixel images by 255. Hereinafter, the operation of obtaining the first classification map 2000 based on the input image 1000 will be described with reference to FIGS. 5A and 5B.

In one or more embodiments of the disclosure, the operating method of the electronic apparatus 100 may include detecting the boundary between the object region 2100 and the background region 2200 included in the obtained first classification map 2000. The at least one processor 500 may execute the boundary detection module 435 to detect the boundary between the object region 2100 and the background region 2200 by binarizing the gray scale included in the first classification map 2000.

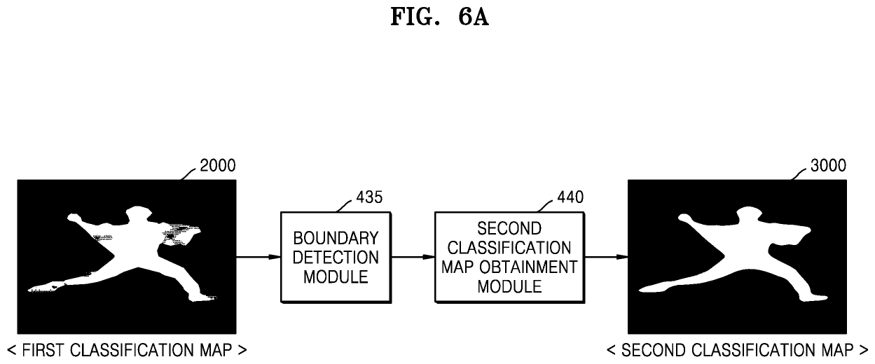

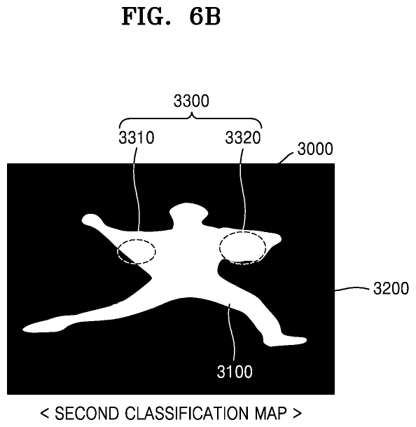

In one or more embodiments of the disclosure, the operating method of the electronic apparatus 100 may include pre-processing the first classification map 2000 to obtain the second classification map 3000 from which the noise region 2300 included in the first classification map 2000 is removed (S300). In one or more embodiments of the disclosure, the at least one processor 500 may execute the second classification map obtainment module 440 to obtain the second classification map 3000 from which the noise region 2300 included in the first classification map 2000 is removed through a morphology process. In one or more embodiments of the disclosure, as part of the morphology process, the at least one processor 500 may execute the second classification map obtainment module 440 to remove the noise region 2300 included in the first classification map 2000 through erosion, dilatation, and/or opening/closing/gradient operations through erosion and dilation. In one or more examples, the at least one processor 500 may execute the second classification map obtainment module 440 to smooth the boundary between the object region 2100 and the background region 2200 included in the first classification map 2000. Hereinafter, the operation of pre-processing the first classification map 2000 to obtain the second classification map 3000 will be described with reference to FIGS. 6A and 6B.

In one or more embodiments of the disclosure, the operating method of the electronic apparatus 100 may include obtaining the first correction coefficient calculated based on the information about the distance between the camera 300 and the object. In one or more embodiments of the disclosure, in the obtaining of the first correction coefficient, the reference distance between the camera 300 and the object may be detected based on the second classification map 3000, and the first correction coefficient may be calculated based on the detected reference distance. The at least one processor 500 may execute the first correction coefficient calculation module 470 to detect the reference distance between the camera 300 and the object based on the second classification map 3000 and obtain the first correction coefficient calculated based on the information about the detected reference distance.

In one or more embodiments of the disclosure, the obtaining of the first correction coefficient may include detecting the distance between the camera 300 and the object based on the second classification map 3000, and calculating the first correction coefficient based on the detected reference distance. The at least one processor 500 may execute the distance detection module 460 to detect the reference distance between the camera 300 and the object based on the second classification map 3000. The at least one processor 500 may execute the first correction coefficient calculation module 470 to obtain the first correction coefficient calculated based on the information about the detected reference distance. Hereinafter, the operation of obtaining the first correction coefficient will be described with reference to FIGS. 7A and 7B.

In one or more embodiments of the disclosure, the operating method of the electronic apparatus 100 may include dividing the classified object region 2100 and the classified background region 2200 based on the detected boundary, and calculating the positions and sizes of the divided object region 2100 and the divided background region 2200. The at least one processor 500 may execute the region division module 445 to divide the object region 2100 and the background region 2200 included in the input image 1000 based on the detected boundary, and calculate the positions and sizes of the divided object region 2100 and the divided background region 2200.

In one or more embodiments of the disclosure, the operating method of the electronic apparatus 100 may include detecting the noise region 2300 included in the first classification map 2000. The at least one processor 500 may execute a noise region detection module 480 to detect the noise region 2300 included in the first classification map 2000. In one or more embodiments of the disclosure, the at least one processor 500 may detect, as the noise region 2300, a region including a pixel image having an object pixel probability value less than the second reference probability value among at least one pixel image included in the divided object region 2100. In one or more embodiments of the disclosure, the second reference probability value may be greater than the first reference probability value. In one or more embodiments of the disclosure, the noise region 2300 is classified as being included in the object region 2100 determined to be a region corresponding to the object based on the first reference probability value, but may be a region including at least one pixel image that is unclear whether it is a pixel image corresponding to the object or a pixel image corresponding to the background of the object.

However, the embodiments are not limited thereto, and the noise region 2300 may be included in the background region 2200 determined to be the region corresponding to the background of the object based on the first reference probability value. The noise region 2300 may be a region including a pixel image having an object pixel probability value that is less than the first reference probability value but greater than or equal to the third reference probability value. In one or more embodiments of the disclosure, the third reference probability value may be less than the first reference probability value. In one or more embodiments of the disclosure, the noise region 2300 is classified as being included in the background region 2200 determined to be a region corresponding to the background of the object based on the first reference probability value, but may also be a region including at least one pixel image where it is unclear whether this pixel image corresponds to the object or corresponds to the background of the object.

Hereinafter, for convenience of description, the noise region 2300 will be described as a region included in the object region 2100.

In one or more embodiments of the disclosure, the operating method of the electronic apparatus 100 may include obtaining the second correction coefficient calculated based on the noise region 2300 included in the first classification map 2000. In one or more embodiments of the disclosure, the second correction coefficient may be calculated based on the detected noise region 2300. The at least one processor 500 may execute the second correction coefficient calculation module 491 to obtain the second correction coefficient calculated based on the detected noise region 2300. Hereinafter, the operation of obtaining the second correction coefficient will be described with reference to FIGS. 8A and 8B.

In one or more embodiments of the disclosure, the operating method of the electronic apparatus 100 may include obtaining the third correction coefficient calculated based on the noise region 2300 included in the first classification map 2000. In one or more embodiments of the disclosure, in the obtaining of the third correction coefficient, the third correction coefficient calculated based on the object pixel probability of the at least one pixel image included in the detected noise region 2300 may be obtained. The at least one processor 500 may execute the third correction coefficient calculation module 492 to obtain the third correction coefficient calculated based on the object pixel probability of the at least one pixel image included in the detected noise region 2300. Hereinafter, the operation of obtaining the second correction coefficient will be described with reference to FIGS. 8A and 8B.

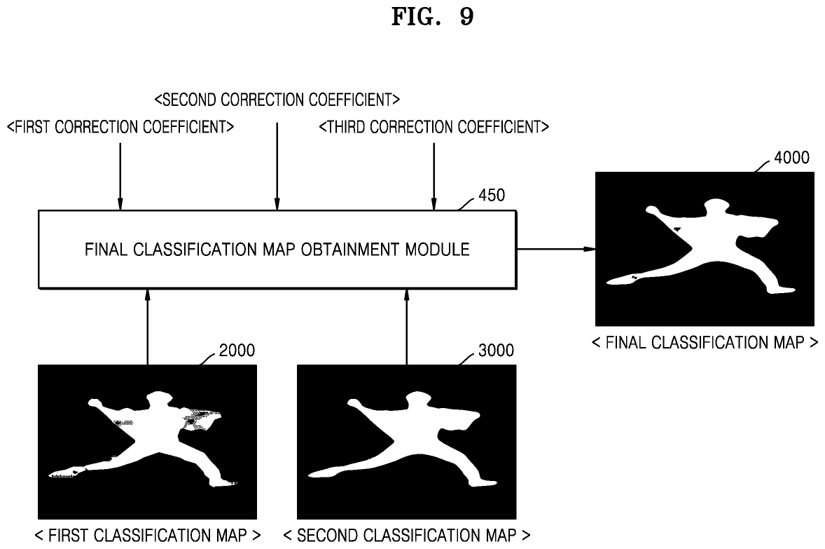

In one or more embodiments of the disclosure, the operating method of the electronic apparatus 100 may include obtaining the final classification map 4000 based on the first correction coefficient, the second correction coefficient, the first classification map 2000, and the second classification map 3000 (S400). In one or more embodiments of the disclosure, in the obtaining of the final classification map 4000 (S400), the final classification map 4000 may be obtained based on the first correction coefficient, the second correction coefficient, the third correction coefficient, the first classification map 2000, and the second classification map 3000. Hereinafter, the operation of obtaining the final classification map 4000 will be described with reference to FIG. 9.

In one or more embodiments of the disclosure, the operating method of the electronic apparatus 100 may include obtaining the object image 5000 corresponding to the object 110 by applying the final classification map 4000 to the input image 1000 (S500). In one or more embodiments of the disclosure, in the obtaining of the object image 5000 (S500), the object image 5000 corresponding to the object may be obtained based on the first classification map 2000 and the second classification map 3000 by using the noise region 2300 and the information about the distance between the camera 300 and the object. In one or more embodiments of the disclosure, the at least one processor 500 may obtain the object image 5000 corresponding to the object by applying the final classification map 4000 to the input image 1000.

FIG. 5A is a diagram for describing the operation of obtaining the first classification map, according to one or more embodiments of the disclosure. FIG. 5B is a diagram for describing the first classification map according to one or more embodiments of the disclosure.

Referring to FIGS. 4 and 5A, in one or more examples, the input image 1000 may be an image obtained by photographing or capturing an image of a person throwing a ball and a background of the person throwing the ball. The at least one processor 500 may execute the image obtainment module 410 to obtain the input image 1000 including the person throwing the ball as the object and the background of the person throwing the ball as the background of the object.

In one or more embodiments of the disclosure, the at least one processor 500 may execute the probability calculation module 420 to calculate the object pixel probability value of each of the pixel images included in the image corresponding to the person throwing the ball, and the object pixel probability value of each of the pixel images included in the image corresponding to the background of the person throwing the ball. Accordingly, each pixel image may be classified as either the object or the background based on the calculated object pixel probability value. In one or more embodiments of the disclosure, the probability calculation module 420 may include a pre-trained AI model based on a training dataset labeled with the person and the background of the person. In one or more embodiments of the disclosure, the object pixel probability value of each of the pixel images included in the image corresponding to the person throwing the ball may be greater than the object pixel probability value of each of the pixel images included in the image corresponding to the background of the person throwing the ball.

In one or more embodiments of the disclosure, the at least one processor 500 may execute the first classification map obtainment module 430 to classify the input image 1000 into at least one pixel image having an object pixel probability value equal to or greater than a preset first reference probability value and at least one pixel image having an object pixel probability value less than the first reference probability value. In one or more embodiments of the disclosure, the first reference probability value may be set to a probability value determined to be a criterion for classifying the person and the background of the person according to a weight of the probability calculation module 420 pre-trained to classify the person and the background of the person.

The at least one processor 500 may execute the first classification map obtainment module 430 to classify, as the object region 2100, the region of the input image 1000 in which at least one pixel image having an object pixel probability value equal to or greater than the first reference probability value is disposed adjacent to each other. In one or more embodiments of the disclosure, because the pixel images corresponding to the person throwing the ball have an object pixel probability value equal to or greater than the first reference probability value and are disposed adjacent to each other, the at least one processor 500 may classify, as the object region 2100, the region corresponding to the person throwing a ball.

The at least one processor 500 may execute the first classification map obtainment module 430 to classify, as the background region 2200, the region of the input image 1000 in which at least one pixel image having an object pixel probability value less than the first reference probability value is disposed. In one or more embodiments of the disclosure, because the pixel images corresponding to the person throwing the ball have an object pixel probability value less than the first reference probability value and are disposed adjacent to each other, the at least one processor 500 may classify, as the background region 2200, the region corresponding to the background of the person throwing a ball.

In one or more embodiments of the disclosure, at least one pixel image having an object probability value less than the preset second reference probability value may be associated with the region classified into the object region 2100. In one or more embodiments of the disclosure, at least one pixel image having an object probability value equal to or greater than the second reference probability value may be an image with a high degree of certainty of corresponding to the person throwing the ball beyond a possible error range that may occur in the at least one processor 500 that executes the first classification map obtainment module 430 to classify the input image 1000 into the object region 2100 and the background region 2200. At least one pixel image having an object probability value less than the second reference probability value may be an image that is classified as the object region 2100, but has a possibility of being a pixel image corresponding to the background of the person throwing the ball.

In one or more embodiments of the disclosure, the at least one processor 500 may execute the first classification map obtainment module 430 to obtain the first classification map 2000 having a gray scale between 0 and 255 by multiplying the object pixel probability value of each of the pixel images included in the input image 1000 by 255. The first classification map 2000 may include an object region 2100 multiplied by 255 and a background region 2200 multiplied by 255.

Referring to FIG. 5B, in one or more embodiments of the disclosure, because the object pixel probability value of each of the pixel images included in the object region 2100 is greater than the object pixel probability value of each of the pixel images included in the background region 2200, the object region 2100 included in the first classification map 2000 may have a gray scale that is higher than that of the background region 2200. Accordingly, in one or more examples, the object region 2100 included in the first classification map 2000 may be displayed as a brighter region than the background region 2200.

In one or more embodiments of the disclosure, the first classification map 2000 may include the noise region 2300 included in the object region 2100. In one or more examples, at least one pixel image included in the remaining regions of the object region 2100 except for the noise region 2300 has an object pixel value greater than the second reference probability value.

In one or more embodiments of the disclosure, the noise region 2300 may include a first noise region 2310 located in the object region 2100, and a second noise region 2320 located at the boundary between the object region 2100 and the background region 2200. In one or more embodiments of the disclosure, because the first noise region 2310 includes at least one pixel image that is located in the object region 2100, but has an object probability value less than the second reference probability value, the first noise region 2310 may have a gray scale that is lower than that of the adjacent object region 2100. In one or more embodiments of the disclosure, because the second noise region 2320 includes at least one pixel image that has an object probability value less than the second reference probability value, the second noise region 2320 may have a gray scale that is higher than that of the adjacent background region 2200.

FIG. 6A is a diagram for describing the operation of obtaining the second classification map, according to one or more embodiments of the disclosure. FIG. 6B is a diagram for describing the second classification map according to one or more embodiments of the disclosure.

Referring to FIGS. 1, 4, and 6A, in one or more embodiments of the disclosure, the at least one processor 500 may execute the boundary detection module 435 to detect the boundary between the object region 2100 corresponding to the person throwing the ball and the background region 2200 corresponding to the background of the person throwing the ball, the object region 2100 and the background region 2200 being included in the first classification map 2000. In one or more embodiments of the disclosure, the at least one processor 500 may binarize the gray scale of the first classification map 2000 to detect the boundary so that the object region 2100 and the background region 2200 is clearly distinguishable from each other. The binarization process may include classifying a pixels as “1” or “0”, where a value of 1 indicates an object, and a value of 0 indicates a background. A boundary may be detected where pixel with a value of 0 is adjacent to a pixel with a value of 1.

In one or more embodiments of the disclosure, the at least one processor 500 may execute the second classification map obtainment module 440 to pre-process the first classification map 2000 to obtain the second classification map 3000 from which the noise region 2300 included in the first classification map 2000 is removed. In one or more embodiments of the disclosure, the at least one processor 500 may execute the second classification map obtainment module 440 to obtain the second classification map 3000 from which the noise region (e.g., 2300 of FIG. 5B) included in the first classification map 2000 is removed through a morphology process. In one or more examples, the at least one processor 500 may execute the second classification map obtainment module 440 to obtain the second classification map 3000 by smoothing the boundary between the object region 2100 and the background region 2200 included in the first classification map 2000.

Referring to FIGS. 5B and 6B, the second classification map 3000 may include a pre-processed object region 3100 and a pre-processed background region 3200. In one or more embodiments of the disclosure, the pre-processed object region 3100 may be obtained by performing, as the morphology process, erosion, dilation, or opening/closing operations through erosion and dilation on the object region 2100 of the first classification map 2000. Through the above operations, the noise region (e.g., 2300 of FIG. 5B) included in the object region 2100 of the first classification map 2000 may be removed.

Referring to FIGS. 5B and 6B, the gray scale of the pre-processed region 3300 corresponding to the noise region 2300 of the first classification map 2000 in the pre-processed object region 3100 may be equal to the gray scale of the adjacent pre-processed object region 3100. In one or more embodiments of the disclosure, the pre-processed region 3310 corresponding to the first noise region 2310 may have a gray scale that is equal to that of the adjacent pre-processed object region 3100. The pre-processed region 3320 corresponding to the second noise region 2320 may have a gray scale that is equal to that of the adjacent pre-processed object region 3100 and is higher than that of the adjacent pre-processed background region 3200.

In one or more embodiments of the disclosure, unlike the object region 2100 of the first classification map 2000, the noise region 2300 is not included in the pre-processed object region 3100. Accordingly, at least one pixel image included in the pre-processed object region 3100 included in the second classification map 3000 may be recognized as a pixel image corresponding to the object that is the person throwing the ball.

Referring to FIGS. 5B and 6B, the second classification map 3000 may be obtained by removing noise included in the boundary included in the first classification map 2000. In one or more embodiments of the disclosure, the second classification map 3000 may be obtained by removing the second noise region 2320 included in the first classification map 2000. Therefore, the boundary between the pre-processed object region 3100 corresponding to the person throwing the ball and the pre-processed background region 3200 corresponding to the background of the person throwing the ball, the pre-processed object region 3100 and the pre-processed background region 3200 being included in the second classification map 3000, may be more readily identifiable than the boundary between the object region 2100 corresponding to the person throwing the ball and the background region 2200 corresponding to the background of the person throwing the ball, the object region 2100 and the background region 2200 being included in the first classification map 2000.

FIG. 7A is a diagram for describing the operation of obtaining the first correction coefficient, according to one or more embodiments of the disclosure. FIG. 7B is a diagram for describing the first correction coefficient according to one or more embodiments of the disclosure.

Referring to FIGS. 4, 6B, and 7A, in one or more embodiments of the disclosure, the at least one processor 500 may execute the distance detection module 460 to detect the reference distance, which is the distance between the camera (e.g., 300 of FIG. 1) capturing the input image (e.g., 1000 of FIG. 5A) and the object (e.g., the person throwing the ball), based on the second classification map 3000.

In one or more embodiments of the disclosure, the memory (e.g., 400 of FIG. 2) may further store a size-based module 461, a joint-based module 462, and a depth-based module 463. The at least one processor 500 may execute at least one of the size-based module 461, the joint-based module 462, or the depth-based module 463 to detect the reference distance between the camera 300 and the object, based on the second classification map 3000. However, all of the modules illustrated in FIG. 7A are merely examples. The memory 400 may store more modules than the modules illustrated in FIG. 7A, or may store fewer modules than the modules illustrated in FIG. 7A. In one or more embodiments of the disclosure, the memory 400 may further include a module including instructions or program code related to another operation or function of detecting the reference distance between the camera 300 and the object based on the second classification map 3000.

Referring to FIGS. 7A and 7B, the sizes of object regions 3100_1 and 3100_2 included in second classification maps 3000_1 and 3000_2 may vary according to a distance between a camera 300 and an object 110. In one or more embodiments of the disclosure, the size of the object region included in the input image (e.g., 1000 of FIG. 5A) obtained through the camera 300 may be in inverse proportion to the distance between the camera 300 and the object 110.

In one or more embodiments of the disclosure, the second classification map 3000_1 when the distance between the camera 300 and the object 110 is a first reference distance 501 may be defined as a first sub-classification map 3000_1, and the second classification map 3000_2 when the distance between the camera 300 and the object 110 is a second reference distance 502 may be defined as a second sub-classification map 3000_2. In this case, the first reference distance 501 may be shorter than the second reference distance 502. In one or more examples, the reference distances may be determined based on a zoom power of a lens of a camera at the time an image is captured.

In one or more embodiments of the disclosure, the object region 3100_1 included in the first sub classification map 3000_1 may be defined as a first sub-object region 3100_1, and a background region 3200_1 included in the first sub-classification map 3000_1 may be defined as a first sub-background region 3200_1. In one or more embodiments of the disclosure, the object region 3100_2 included in the second sub-classification map 3000_2 may be defined as a second sub-object region 3100_2, and a background region 3200_2 included in the second sub-classification map 3000_2 may be defined as a second sub-background region 3200_1.

In one or more embodiments of the disclosure, the size of the first sub-object region 3100_1 may be greater than the size of the second sub-object region 3100_2. The size of a specific region (e.g., a person's head or a person's hand) of the person throwing the ball in the first sub-object region 3100_1 may be greater than the size of a region of the second sub-object region 3100_2 corresponding to the specific region of the person throwing the ball included in the first sub-object region 3100_1.

In one or more embodiments of the disclosure, the size-based module 461 may include instructions or program code related to an operation or function of detecting the reference distance between the camera 300 and the object, based on the difference between the size of the first sub-object region 3100_1 included in the first sub-classification map 3000_1 and the size of the second sub-object region 3100_2 included in the second sub-classification map 3000_2 according to the difference between the first reference distance 501 and the second reference distance 502.

In one or more embodiments of the disclosure, the joint-based module 462 may include instructions or program code related to an operation or function of obtaining a point corresponding to a persons' joint in a human-like image through kinetic chain analysis and detecting the reference distance between the camera 300 and the object based on the obtained point. In one or more embodiments of the disclosure, the joint-based module 462 may include instructions or program code related to an operation or function of detecting the reference distance between the camera 300 and the object, based on the difference between the number or position of at least one point included in the first sub-object region 3100_1 and the number or position of at least one point included in the second sub-object region 3100_2 according to the difference between the first reference distance 501 and the second reference distance 502.

In one or more embodiments of the disclosure, when the camera 300 includes an RGB-depth camera, the at least one processor (e.g., 500 of FIG. 2) may obtain the input image 1000 and a depth map corresponding to the input image 1000. In one or more embodiments of the disclosure, the depth map refers to an image including information about a depth value from a reference point to a surface of an object. In one or more embodiments of the disclosure, when the reference point is the position of the camera 300, the depth map may include depth information of the object and the background of the object, which are photographed by the camera 300. In one or more embodiments of the disclosure, the depth-based module 463 may include instructions or program code related to an operation or function of detecting the reference distance between the camera 300 and the object, based on the obtained depth map.

In one or more embodiments of the disclosure, the at least one processor 500 may execute the first correction coefficient calculation module 470 to obtain the first correction coefficient (wD) calculated based on the detected reference distance. In one or more embodiments of the disclosure, as the length of the detected reference distance increases, the magnitude of the first correction coefficient (wD) may increase.

In one or more embodiments of the disclosure, the first correction coefficient (wD) calculated based on the detected reference distance includes a first sub-correction coefficient and a second sub-correction coefficient. The at least one processor 500 may calculate the first sub-correction coefficient (1−wD) and the second sub-correction coefficient (wD) based on the first correction coefficient (wD) In one or more embodiments of the disclosure, the second sub-correction coefficient (wD) may be equal to the first correction coefficient (wD). In one or more embodiments of the disclosure, as the length of the reference distance increases, the magnitude of the first sub-correction coefficient (1−wD) may decrease. As the length of the reference distance increases, the magnitude of the second sub-correction coefficient (wD) may increase. In one or more embodiments of the disclosure, the sum of the first sub-correction coefficient (1−wD) and the second sub-correction coefficient (wD) may be 1.

FIG. 8A is a diagram for describing the operation of obtaining the second correction coefficient and the third correction coefficient, according to one or more embodiments of the disclosure. FIG. 8B is a diagram for describing the second correction coefficient and the third correction coefficient according to one or more embodiments of the disclosure.

Referring to FIGS. 4, 8A, and 8B, in one or more embodiments of the disclosure, the at least one processor 500 may execute the noise region detection module 480 to detect the noise region 2300 included in the first classification map 2000. In one or more embodiments of the disclosure, the first classification map 2000 includes the object region 2100 corresponding to the person throwing the ball and the background region 2200 corresponding to the background of the person throwing the ball. In this case, the object region 2100 may be a region classified as a region including a plurality of pixel images each having an object pixel probability value equal to or greater than a preset first reference probability value.

The at least one processor 500 may execute the noise region detection module 480 to detect at least one pixel image having an object pixel probability value less than a preset second reference probability value in the object region 2100 and detect, as the noise region 2300, a region including the detected at least one pixel image.

In one or more embodiments of the disclosure, the noise region 2300 may be classified as being included in the object region 2100 corresponding to the person throwing the ball, but may be a region including a pixel image where it is unclear whether the image is a pixel image corresponding to the object or a pixel image corresponding to the background of the object, due to limitations in the detection performance of the at least one processor 500 that executes the noise region detection module 480 to classify the object region 2100 and the background region 2200.

Furthermore, in one or more embodiments of the disclosure, the noise region 2300 may be classified by the at least one processor 500 as being included in the object region 2100 corresponding to the person throwing the ball, but may be a region including a pixel image where it is unclear whether the image is a pixel image corresponding to the object or a pixel image corresponding to the background of the object because the distance between the camera 300 and the object is greater than the first reference distance and the resolution of the input image 1000 obtained through the camera 300 is low.

In one or more embodiments of the disclosure, the at least one processor 500 may execute the noise region detection module 480 to detect the noise region 2300 included in the object region 2100. FIG. 8B illustrates that a region corresponding to a person's hand, a region corresponding to a person's foot, a region corresponding to a part between a person's arm and a person's waist, and a region corresponding to a person's knee in the object region 2100 corresponding to the person throwing the ball are detected as the noise region 2300. In one or more embodiments of the disclosure, the noise region 2300 may be a region corresponding to a part of the object with large motion. However, the embodiments are not limited thereto, and the number, position, size, and the like of the noise region 2300 may be changed according to the type of object, the motion of the object, and the like.

In one or more embodiments of the disclosure, the at least one processor 500 may execute the second correction coefficient calculation module 491 to obtain the second correction coefficient (wU) calculated based on region 2300. In one or more embodiments of the disclosure, as a ratio of the noise region 2300 to the object region 2100 included in the first correction map 2000 increases, the magnitude of the second correction coefficient (wU) may increase.

In one or more embodiments of the disclosure, the at least one processor 500 may calculate the second correction coefficient (wU) based on at least one of the ratio of the noise region 2300 to the object region 2100 included in the first classification map 2000, the number of noise regions 2300 included in the first classification map 2000, or the area of the noise region 2300 included in the first classification map 2000. In one or more embodiments of the disclosure, as the number of noise regions 2300 included in the first classification map 2000 increases, the magnitude of the second correction coefficient (wU) may increase. In one or more embodiments of the disclosure, as the area of the noise region 2300 included in the first classification map 2000 increases, the magnitude of the second correction coefficient (wU) may increase.

In one or more embodiments of the disclosure, the area of the noise region 2300 may be relatively small, compared to the area of the object region 2100 included in the first correction map 2000. Even when the noise region 2300 detected by the least one processor 500 increases, a change in the ratio of the noise region 2300 to the object region 2100 included in the first correction map 2000 may not be great. In this case, even when the detected noise region 2300 increases, the change in the magnitude of the second correction coefficient (wU) may be small.

In this case, when the magnitude of the second correction coefficient (wU) is calculated based on the number of detected noise regions 2300 and the area of the noise regions 2300, the magnitude of the second correction coefficient (wU) may be changed in response to an increase in the noise region 2300 detected by the least one processor 500. Accordingly, the magnitude of the second correction coefficient (wU) may be changed in response to a change in the noise region 2300 included in the object region 2100.

In one or more embodiments of the disclosure, the at least one processor 500 may execute the third correction coefficient calculation module 492 to obtain the third correction coefficient (a) calculated based on the detected noise region 2300. In one or more embodiments of the disclosure, the at least one processor 500 may calculate the third correction coefficient (a) based on the object pixel probability of at least one pixel image included in the noise region 2300. In one or more embodiments of the disclosure, as the object pixel probability value of at least one pixel image included in the noise region 2300 increases, the magnitude of the third correction coefficient (a) may decrease. As the object pixel probability value of at least one pixel image included in the noise region 2300 increases, the corresponding pixel image may be an image that is highly likely to be the object image (e.g., 5000 of FIG. 1) corresponding to the person throwing the ball. As the object pixel probability value of at least one pixel image included in the noise region 2300 decreases, the corresponding pixel image may be an image that is included in the object region 2100 but is highly likely to be the object background image corresponding to the background of the person throwing the ball.

FIG. 9 is a diagram for describing the operation of obtaining the final classification map, according to one or more embodiments of the disclosure.

Referring to FIGS. 4 and 9, the at least one processor 500 may execute the final classification map obtainment module 450 to obtain the final classification map 4000 based on the first classification map 2000 and the second classification map 3000. In one or more embodiments of the disclosure, the at least one processor 500 may execute the final classification map obtainment module 450 to obtain the final classification map 4000 based on the first correction coefficient (wD), the second correction coefficient (wD), the third correction coefficient (a), the first classification map 2000, and the second classification map 3000.

In one or more embodiments of the disclosure, the final classification map obtainment module 450 may include instructions or program code related to an operation or function of obtaining the final classification map 4000 by using the following equation.

$$\{ P {1}_{ij} \times ( 1 - wD ) + P {2}_{ij} \times wD \} + \{ α \times ( P {2}_{ij} \times wU ) \} \qquad Equation$$

In the above equation, P1ᵢⱼ represents the pixel image corresponding to coordinates of (i,j) among the pixel images included in the first classification map 2000, P2ᵢⱼ represents the pixel image corresponding to coordinates of (i,j) among the pixel images included in the second classification map 3000, 1−wD represents the first sub-correction coefficient, wD represents the second sub-correction coefficient, wU represents the second correction coefficient, and a represents the third correction coefficient. In one or more examples, i and j are each a natural number greater than or equal to 1 that may be determined by the resolutions of the first classification map 2000 and the second classification map 3000.

In one or more embodiments of the disclosure, the at least one processor 500 may execute the final classification map obtainment module 450 to obtain the final classification map 4000 by adding the first classification map 2000 obtained based on the input image 1000 to the second classification map 3000 obtained by pre-processing the first classification map 2000, and classify the object image (e.g., 5000 of FIG. 1) and the object background image, which are included in the input image 1000, based on the obtained final classification map 4000. Because the at least one processor 500 obtains the final classification map 4000 based on the first classification map 2000 and the second classification map 3000, the accuracy of the operation of classifying the object image 5000 and object background image, which are included in the input image 1000, may be improved. Hereinafter, in order to improve the accuracy of the operation of classifying the object image 5000 and the object background image, which are included in the input image 1000, the operation of determining the ratio of the first classification map 2000 and the second classification map 3000, which are included in the final classification map 4000, will be described.

In one or more embodiments of the disclosure, the at least one processor 500 may execute the final classification map obtainment module 450 to obtain the final classification map 4000 based on the first classification map 2000 multiplied by the first sub-correction coefficient (1−wD) and the second classification map 3000 multiplied by the second sub-correction coefficient (wD). In one or more embodiments of the disclosure, as the reference distance between the camera (e.g., 300 of FIG. 1) and the object 110 decreases, the magnitude of the first sub correction coefficient (1−wD) increases, and thus, the proportion of the first classification map 2000 may increase in obtaining the final classification map 4000. As the reference distance between the camera (e.g., 300 of FIG. 1) and the object 110 increases, the magnitude of the second sub correction coefficient (wD) decreases, and thus, the proportion of the second classification map 3000 may decrease in obtaining the final classification map 4000.

In one or more embodiments of the disclosure, referring to FIGS. 5A and 5B, the first classification map 2000 is a map obtained by classifying the object region 2100 and the background region 2200 based on the input image 1000. In one or more examples, as the reference distance between the camera 300 and the object 110 decreases, the resolution of the input image 1000 obtained through the camera 300 increases, and thus, the accuracy of the operation of classifying the object region 2100 and the background region 2200 based on the input image 1000 in order to obtain the first classification map 2000 may be improved. In one or more examples, the noise region 2300 included in the first classification map 2000 may decrease. Therefore, as the reference distance between the camera 300 and the object 110 decreases, the proportion of the first classification map 2000 included in the final classification map 4000 increases and the proportion of the second classification map 3000 decreases. Accordingly, the accuracy of the operation of classifying the object image 5000 and the object background image, which are included in the input image 1000, may be improved.

In one or more embodiments of the disclosure, the second classification map 3000 is a map obtained by pre-processing the first classification map 2000 and removing the noise region 2300 included in the first classification map 2000. In one or more embodiments of the disclosure, as the reference distance between the camera 300 and the object 110 increases, the resolution of the input image 1000 obtained through the camera 300 decreases, and thus, the accuracy of the operation of classifying the object region 2100 and the background region 2200 based on the input image 1000 in order to obtain the first classification map 2000 may be reduced. Furthermore, the noise region 2300 included in the first classification map 2000 may increase. Therefore, as the reference distance between the camera 300 and the object 110 increases, the proportion of the first classification map 2000 included in the final classification map 4000 decreases and the proportion of the second classification map 3000 increases. Accordingly, the accuracy of the operation of classifying the object image 5000 and the object background image, which are included in the input image 1000, may be improved.

In one or more embodiments of the disclosure, the at least one processor 500 may execute the final classification map obtainment module 450 to obtain the final classification map 4000 based on the second classification map 3000 multiplied by the second correction coefficient (wU). In one or more embodiments of the disclosure, as the noise region 2300 included in the first classification map 2000 increases, the proportion of the second classification map 3000 may increase in obtaining the final classification map 4000.

In one or more embodiments of the disclosure, referring to FIGS. 6A and 6B, the second classification map 3000 is a map obtained by pre-processing the first classification map 2000 and removing the noise region 2300 included in the first classification map 2000. In one or more embodiments of the disclosure, when the noise region 2300 included in the first classification map 2000 increases due to limitations in the detection performance of the at least one processor 500 that classifies the object region 2100 and the background region 2200, which are included in the input image 1000, or rapid movement of the object, the accuracy of the operation of classifying the object region 2100 and the background region 2200 based on the input image 1000 may be reduced. In this case, the accuracy of the operation of classifying the object image 5000 and the object background image, which are included in the input image 1000, may be improved by decreasing the proportion of the first classification map 2000 included in the final classification map 4000 and increasing the proportion of the second classification map 3000.

In one or more embodiments of the disclosure, when the noise region 2300 included in the first classification map 2000 decreases, the accuracy of the operation of classifying the object region 2100 and the background region 2200 based on the input image 1000 may be improved. In this case, the accuracy of the operation of classifying the object image 5000 and object background image, which are included in the input image 1000, may be improved by increasing the proportion of the first classification map 2000 included in the final classification map 4000 and decreasing the proportion of the second classification map 3000.

In one or more embodiments of the disclosure, the at least one processor 500 may execute the final classification map obtainment module 450 to obtain the final classification map 4000 based on the second classification map 3000 multiplied by the third correction coefficient (a). In one or more embodiments of the disclosure, the at least one processor 500 may obtain the final classification map 4000 based on the second classification map 3000 multiplied by the second correction coefficient (wU) and the third correction coefficient (a). In one or more embodiments of the disclosure, as the object pixel probability value of at least one pixel image included in the noise region 2300 increases, the magnitude of the third correction coefficient (a) decreases, and thus, the proportion of the second classification map 3000 may be reduced in obtaining the final classification map 4000.

In one or more embodiments of the disclosure, as the object pixel probability value of at least one pixel image included in the noise region 2300 increases, the probability that the at least one pixel image included in the noise region 2300 is an image corresponding to the object image increases. Therefore, even when the noise region 2300 is included in the first classification map 2000, the accuracy of the operation of classifying the object region 2100 and the background region 2200 based on the input image 1000 in order to obtain the first classification map 2000 may be improved. In this case, even when the first classification map 2000 includes the noise region 2300, the accuracy of the operation of classifying the object image 5000 and the object background image, which are included in the input image 1000, based on the final classification map 4000 obtained based on the first classification map 2000 may be improved.

In addition, when the proportion of the second classification map 3000 included in the final classification map 4000 increases, the noise region 2300 generated by the motion or the like of the object is excessively compensated. Rather, the accuracy of the operation of classifying the object image 5000 and the object background image, which are included in the input image 1000, may be reduced. Therefore, as the object pixel probability value of at least one pixel image included in the noise region 2300 increases, the portion of the first classification map 2000 included in the final classification map 4000 increases and the proportion of the second classification map 3000 decreases, and thus, the accuracy of the operation of classifying the object image 5000 and object background image, which are included in the input image 1000, may be improved.

FIG. 10 is a diagram for describing effects of the electronic apparatus and the operating method of the electronic apparatus, according to one or more embodiments of the disclosure.

Referring to FIGS. 1 and 10, in the electronic apparatus 100 and the operating method of the electronic apparatus 100, according to one or more embodiments of the disclosure, the final classification map 4000 may be obtained based on the input image 1000 obtained by photographing the object and the background of the object.

In one or more embodiments of the disclosure, the final classification map 4000 may be obtained by adjusting the ratio of the first classification map 2000 to the second classification map 3000, based on the noise region 2300 included in the first classification map 2000 according to the distance between the camera 300 and the object, the motion of the object, or the performance of the electronic apparatus 100.

In one or more embodiments of the disclosure, the electronic apparatus 100 may classify the object image 5000 included in the input image 1000, based on the final classification map 4000. In one or more embodiments of the disclosure, the classified object image 5000 may be an image corresponding to the object region included in the final classification map 4000. However, the embodiments are not limited thereto, and the electronic apparatus that classifies the object image 5000 included in the input image 1000 based on the final classification map 4000 may be separate from the electronic apparatus that obtains the final classification map 4000. In one or more embodiments of the disclosure, the electronic apparatus 100 according to the disclosure may obtain the final classification map 4000 based on the input image 1000 and provide the obtained final classification map 4000 to the separate electronic apparatus that classifies the object image 5000 by applying the final classification map 4000 to the input image 1000.

In one or more embodiments of the disclosure, the electronic apparatus 100 may obtain the background image 6000. The background image 6000 may be an image including a background that is different from the object background image included in the input image 1000. In one or more embodiments of the disclosure, the electronic apparatus 100 may generate a synthesized image 7000 by combining the object image 5000 and the background image 6000 classified by applying the final classification map 4000 to the input image 1000. Accordingly, the electronic apparatus 100 may combine the object 110 with a desired background other than the object background image captured through the camera 300.

In order to solve the technical problems described above, one or more embodiments of the disclosure provides an electronic apparatus 100 including a memory 400 storing at least one instruction and at least one processor 500 configured to execute the at least one instruction stored in the memory 400. In one or more embodiments of the disclosure, the at least one processor 500 may obtain the input image 1000 by photographing the object and the background of the object through the camera 300. The at least one processor 500 may obtain the first classification map 2000 by classifying the obtained input image 1000 into the object region 2100 corresponding to the object and the background region 2200 corresponding to the background of the object. The at least one processor 500 may pre-process the first classification map 2000 to obtain the second classification map 3000 from which the noise region 2300 included in the first classification map 2000 is removed. The at least one processor may obtain the object image 5000 corresponding to the object based on the first classification map 2000 and the second classification map 3000 by using the noise region 2300 and the information about the distance between the camera 300 and the object.

In one or more embodiments of the disclosure, the at least one processor 500 may obtain the final classification map 4000 based on the first classification map 2000 and the second classification map 3000 by using the noise region 2300 and the information about the distance between the camera 300 and the object. The at least one processor 500 may obtain the object image 5000 by applying the final classification map 4000 to the input image 1000.

In one or more embodiments of the disclosure, the second classification map 3000 may be a classification map obtained by performing morphology on the first classification map 2000.

In one or more embodiments of the disclosure, the at least one processor 500 may calculate the first correction coefficient based on the information about the distance between the camera 300 and the object. In obtaining the final classification map 4000, the first correction coefficient may include the first sub-correction coefficient multiplied by the first classification map 2000 and the second sub-correction coefficient multiplied by the second classification map 3000. As the distance between the camera 300 and the object increases, the magnitude of the first sub-correction coefficient may decrease, and as the distance between the camera 300 and the object increases, the magnitude of the second sub-correction coefficient may increase. The at least one processor 500 may obtain the object image 5000 based on the first classification map 2000 multiplied by the first sub-correction coefficient and the second classification map 3000 multiplied by the second sub-correction coefficient.

In one or more embodiments of the disclosure, the sum of the first sub-correction coefficient and the second sub-correction coefficient may be 1.

In one or more embodiments of the disclosure, the at least one processor 500 may calculate the second correction coefficient based on the noise region 2300. As the ratio of the noise region 2300 to the object region 2100 included in the first correction map 2000 increases, the magnitude of the second correction coefficient may increase. The at least one processor 500 may obtain the object image 5000 based on the second classification map 3000 multiplied by the second correction coefficient.

In one or more embodiments of the disclosure, the second correction coefficient may be calculated based on at least one of the ratio of the noise region 2300 to the object region 2100, the number of noise regions 2300, or the area of the noise region 2300.

In one or more embodiments of the disclosure, the input image 1000 may include a plurality of pixel images. The at least one processor 500 may calculate a probability value of the probability that each of the pixel images corresponds to the object, based on the input image 1000. The at least one processor 500 may obtain the first classification map 2000 by classifying the pixel images into the object region 2100 and the background region 2200, based on the arrangement of the pixel images and a result of comparing the preset first reference probability value with the calculated probability value.

In one or more embodiments of the disclosure, after obtaining the first classification map 2000, the at least one processor 500 may classify the noise region 2300 included in the object region 2100, based on a result of comparing the preset second reference probability value with the probability value of the probability that at least one pixel image included in the classified object region 2100 among the pixel images corresponds to the object. In one or more embodiments of the disclosure, the first reference probability value may be different from the second reference probability value.

In one or more embodiments of the disclosure, the at least one processor 500 may obtain the object image 5000, based on the first classification map 2000 and the second classification map 3000, by using the first correction coefficient, the second correction coefficient, and the third correction coefficient calculated based on the probability value of the probability that at least one pixel image included in the noise region 2300 corresponds to the object.

In one or more embodiments of the disclosure, the third correction coefficient may be in inverse proportion to the probability value of the probability that at least one pixel image included in the noise region 2300 corresponds to the object. The at least one processor 500 may obtain the object image 5000 based on the second classification map 3000 multiplied by the third correction coefficient.

In order to solve the technical problems described above, one or more embodiments of the disclosure provides an operating method of the electronic apparatus 100. In one or more embodiments of the disclosure, the operating method of the electronic apparatus 100 may include obtaining the input image 1000 by photographing the object and the background of the object through the camera 300 (S100). The operating method of the electronic apparatus 100 may include obtaining the first classification map 2000 by classifying the obtained input image 1000 into the object region 2100 corresponding to the object and the background region 2200 corresponding to the background of the object (S200). The operating method of the electronic apparatus 100 may include pre-processing the first classification map 2000 to obtain the second classification map 3000 from which the noise region 2300 included in the first classification map 2000 is removed (S300). The operating method of the electronic apparatus 100 may include obtaining the object image 5000 corresponding to the object, based on the first classification map 2000 and the second classification map 3000, by using the noise region 2300 and the information about the distance between the camera 300 and the object.

In one or more embodiments of the disclosure, the operating method of the electronic apparatus 100 may further include obtaining the final classification map 4000, based on the first classification map 2000 and the second classification map 3000, by using the noise region 2300 and the information about the distance between the camera 300 and the object. In one or more embodiments of the disclosure, in the obtaining of the object image 5000 (S500), the object image 5000 may be obtained by applying the final classification map 4000 to the input image 1000.

In one or more embodiments of the disclosure, the first correction coefficient calculated based on the information about the distance between the camera 300 and the object may include the first sub-correction coefficient multiplied by the first classification map 2000 and the second sub-correction coefficient multiplied by the second classification map 3000 in obtaining the object image 5000. As the distance between the camera 300 and the object increases, the magnitude of the first sub-correction coefficient may decrease, and as the distance between the camera 300 and the object increases, the magnitude of the second sub-correction coefficient may increase. In the obtaining of the object image 5000 (S500), the object image 5000 may be obtained based on the first classification map 2000 multiplied by the first sub-correction coefficient and the second classification map 3000 multiplied by the second sub-correction coefficient.

In one or more embodiments of the disclosure, as the ratio of the noise region 2300 to the object region 2100 included in the first classification map 2000 increases, the magnitude of the second correction coefficient calculated based on the noise region 2300 may increase. In the obtaining of the object image 5000 (S500), the object image 5000 may be obtained based on the second classification map 3000 multiplied by the second correction coefficient.

In one or more embodiments of the disclosure, the second correction coefficient may be calculated based on at least one of the ratio of the noise region 2300 to the object region 2100, the number of noise regions 2300, or the area of the noise region 2300.

In one or more embodiments of the disclosure, the input image 1000 may include a plurality of pixel images. The operating method of the electronic apparatus 100 may further include calculating the probability value of the probability that each of the pixel images corresponds to the object, based on the input image 1000. In the obtaining of the first classification map (S200), the first classification map 2000 may be obtained by classifying the pixel images into the object region 2100 and the background region 2200, based on the arrangement of the pixel images and a result of comparing the preset first reference probability value with the calculated probability value.

In one or more embodiments of the disclosure, the operating method of the electronic apparatus 100 may further include, after obtaining the first classification map 2000, classifying the noise region 2300 included in the object region 2100, based on a result of comparing the preset second reference probability value with the probability value of the probability that at least one pixel image included in the classified object region 2100 among the pixel images corresponds to the object. In one or more embodiments of the disclosure, the first reference probability value may be different from the second reference probability value.

In one or more embodiments of the disclosure, in the obtaining of the object image 5000 (S500), the object image 5000 may be obtained based on the first correction coefficient, the second correction coefficient, and the third correction coefficient calculated based on the probability value of the probability that at least one pixel image included in the noise region 2300 corresponds to the object.

In one or more embodiments of the disclosure, the third correction coefficient may be in inverse proportion to the probability value of the probability that at least one pixel image included in the noise region 2300 corresponds to the object. In the obtaining of the object image 5000 (S500), the object image 5000 may be obtained based on the second classification map 3000 multiplied by the third correction coefficient.

In one or more embodiments of the disclosure, a computer-readable recording medium having recorded thereon a program for causing a computer to perform at least one of the operating methods of the electronic apparatus 100 according to the embodiments of the disclosure may be provided.

The operating methods performed by the electronic apparatus 100, as described above, may be implemented as a hardware component, a software component, and/or a combination of the hardware component and the software component. The program may be executed by any system capable of executing computer-readable instructions.

The software may include a computer program, code, instructions, or a combination of one or more thereof, and may configure a processor to operate as desired or may instruct the processor independently or collectively.

The software may be implemented as a computer program including instructions stored in a computer-readable storage medium. Examples of the computer-readable recording medium may include a magnetic storage medium (e.g., read-only memory (ROM), random-access memory (RAM), floppy disk, hard disk, etc.) and an optical readable medium (e.g., compact disc-ROM (CD-ROM), digital versatile disc (DVD), etc.). The computer-readable recording medium may be distributed in network-connected computer systems, and computer-readable code may be stored and executed in a distributed manner. The recording medium may be readable by a computer, may be stored in a memory, and may be executed by a processor.

The computer-readable storage medium may be provided in the form of a non-transitory storage medium. The “non-transitory storage medium” is a tangible device and only means not including a signal (e.g., electromagnetic wave). This term does not distinguish between a case where data is semi-permanently stored in a storage medium and a case where data is temporarily stored in a storage medium. For example, the non-transitory computer-readable recording medium may include a buffer in which data is temporarily stored.

Also, the methods according to various embodiments of the disclosure disclosed herein may be provided by being included in a computer program product. The computer program products may be traded between a seller and a buyer as commodities.

The computer program product may include a software program, a computer-readable storage medium storing the software program. The computer program product may include a product (e.g., a downloadable application) in the form of a software program that is electronically distributed through a manufacturer of the electronic apparatus 100 or an electronic market (e.g., a Samsung galaxy store). For electronic distribution, at least a part of the software program may be stored in a storage medium, or may be temporarily generated. In this case, the storage medium may be a storage medium of a server of a manufacturer of the electronic apparatus 100, a server of an electronic market, or a relay server temporarily storing a software program.

As described above, although various embodiments of the disclosure have been described with reference to the drawings, various modifications and variations may be made thereto by those of ordinary skill in the art. For example, appropriate results may be achieved even when the technologies described above are performed in an order different from the methods described above, and/or components of the computer system or modules described above are coupled or combined in a manner different from the methods described above or are replaced or substituted for other components or equivalents.

What is claimed is:

1. An electronic apparatus comprising:
a memory storing at least one instruction; and
at least one processor configured to execute the at least one instruction to:
obtain an input image by capturing an object and a background of the object through a camera;
obtain a first classification map by classifying a first part of the obtained input image as an object region corresponding to the object and a second part of the obtained input image as a background region corresponding to the background of the object;
pre-process the first classification map to obtain a second classification map in which a noise region in the first classification map is removed; and
obtain an object image corresponding to the object, based on the first classification map and the second classification map, by using the noise region in the first classification map and information about a distance between the camera and the object.

2. The electronic apparatus of claim 1, wherein the at least one processor is further configured to execute the at least one instruction to:
obtain a final classification map, based on the first classification map and the second classification map, by using the noise region in the first classification map and the information about the distance between the camera and the object; and
obtain the object image by applying the final classification map to the input image.

3. The electronic apparatus of claim 1, wherein the second classification map is a classification map obtained by performing a morphology process on the first classification map.

4. The electronic apparatus of claim 1, wherein the at least one processor is further configured to execute the at least one instruction to determine a first correction coefficient based on the information about the distance between the camera and the object,
the first correction coefficient comprises a first sub-correction coefficient and a second sub-correction coefficient,
as the distance between the camera and the object increases, a magnitude of the first sub-correction coefficient decreases, and as the distance between the camera and the object increases, a magnitude of the second sub-correction coefficient increases, and
the at least one processor is further configured to execute the at least one instruction to obtain the object image based on the first classification map multiplied by the first sub-correction coefficient and the second classification map multiplied by the second sub-correction coefficient.

5. The electronic apparatus of claim 4, wherein the at least one processor is further configured to execute the at least one instruction to determine a second correction coefficient based on the noise region,
as a ratio of the noise region to the object region in the first classification map increases, a magnitude of the second correction coefficient increases, and
the at least one processor is further configured to execute the at least one instruction to obtain the object image based on the second classification map multiplied by the second correction coefficient.

6. The electronic apparatus of claim 5, wherein the second correction coefficient is determined based on at least one of the ratio of the noise region to the object region, a number of noise regions, or an area of the noise region.

7. The electronic apparatus of claim 6, wherein the input image comprises a plurality of pixel images, and
the at least one processor is further configured to execute the at least one instruction to:
determine, for each pixel image in the plurality of pixel images, a probability value of a probability that a respective pixel image corresponds to the object based on the input image; and
obtain the first classification map by classifying each pixel image in the plurality of pixel images as one of the object region and the background region based on an arrangement of the plurality of pixel images and a result of comparing a preset first reference probability value with the determined probability value for each pixel image.

8. The electronic apparatus of claim 7, wherein the at least one processor is further configured to execute the at least one instruction to, after obtaining the first classification map, classify the noise region in the object region, based on a result of comparing a preset second reference probability value with a probability value of a probability that at least one pixel image from the plurality of pixel images in the classified object region corresponds to the object, and
the second reference probability value is different from the first reference probability value.

9. The electronic apparatus of claim 8, wherein the at least one processor is further configured to execute the at least one instruction to obtain the object image, based on the first classification map and the second classification map, by using the first correction coefficient, the second correction coefficient, and a third correction coefficient determined based on a probability value of a probability that at least one pixel image in the noise region corresponds to the object.

10. The electronic apparatus of claim 9, wherein the third correction coefficient is inversely proportional to the probability value of the probability that the at least one pixel image in the noise region corresponds to the object, and
the at least one processor is further configured to execute the at least one instruction to obtain the object image based on the second classification map multiplied by the third correction coefficient.

11. An operating method of an electronic apparatus, the operating method comprising:
obtaining an input image by capturing an object and a background of the object through a camera;
obtaining a first classification map by classifying a first part of the obtained input image as an object region corresponding to the object and a second part of the obtained input image as a background region corresponding to the background of the object;
pre-processing the first classification map to obtain a second classification map in which a noise region in the first classification map is removed; and
obtaining an object image corresponding to the object, based on the first classification map and the second classification map, by using the noise region in the first classification map and information about a distance between the camera and the object.

12. The operating method of claim 11, further comprising obtaining a final classification map, based on the first classification map and the second classification map, by using the noise region in the first classification map and the information about the distance between the camera and the object,
wherein the obtaining of the object image comprises obtaining the object image by applying the final classification map to the input image.

13. The operating method of claim 11, wherein a first correction coefficient determined based on the information about the distance between the camera and the object comprises a first sub-correction coefficient and a second sub-correction coefficient,
as the distance between the camera and the object increases, a magnitude of the first sub-correction coefficient decreases, and as the distance between the camera and the object increases, a magnitude of the second sub-correction coefficient increases, and
the obtaining of the object image comprises obtaining the object image based on the first classification map multiplied by the first sub-correction coefficient and the second classification map multiplied by the second sub-correction coefficient.

14. The operating method of claim 13, wherein, as a ratio of the noise region to the object region in the first classification map increases, a magnitude of a second correction coefficient determined based on the noise region increases, and
the obtaining the object image comprises obtaining the object image based on the second classification map multiplied by the second correction coefficient.

15. The operating method of claim 14, wherein the second correction coefficient is determined based on at least one of the ratio of the noise region to the object region, a number of noise regions, or an area of the noise region.

16. The operating method of claim 15, wherein the input image comprises a plurality of pixel images,
the operating method of the electronic apparatus further comprises determining, for each pixel image in the plurality of pixel images, a probability value of a probability that a respective pixel image corresponds to the object based on the input image, and
the obtaining the first classification map comprises obtaining the first classification map by classifying each pixel image in the plurality of pixel images as one of the object region and the background region based on an arrangement of the plurality of pixel images and a result of comparing a preset first reference probability value with the determined probability value.

17. The operating method of claim 16, further comprising, after the obtaining the first classification map, classifying the noise region in the object region, based on a result of comparing a preset second reference probability value with a probability value of a probability that at least one pixel image from the plurality of pixel images in the classified object region corresponds to the object,
wherein the first reference probability value is different from the second reference probability value.

18. The operating method of claim 17, wherein the obtaining the object image comprises obtaining the object image based on the first classification map and the second classification map, by using the first correction coefficient, the second correction coefficient, and a third correction coefficient determined based on a probability value of a probability that at least one pixel image in the noise region corresponds to the object.

19. The operating method of claim 18, wherein the third correction coefficient is inversely proportional to the probability value of the probability that the at least one pixel image included in the noise region corresponds to the object, and
the obtaining the object image comprises obtaining the object image based on the second classification map multiplied by the third correction coefficient.

20. A non-transitory computer-readable recording medium having instructions stored therein, which when executed by a processor in an electronic apparatus cause the processor to perform the operating method of claim 11.
